(19) United States
(12) Patent Application Publication
(10) Pub. No.: US 2012/0223797 A1
(43) Pub. Date: Sep. 6, 2012

(54) CHOKE COIL

(75) Inventors: Jae Sun WON, Suwon-si (KR); Sang Kyoo HAN, Daejeon-si (KR); Mi Ran BAEK, Hanam-si (KR); Hee Seung KIM, Seoul (KR); Jae Cheol JU, Daejeon-si (KR); Don Sik KIM, Gunpo-si (KR); Jong Hae KIM, Suwon-si (KR); Dong Jin LEE, Suwon-si (KR); Chung Wook RHO, Seoul (KR); Sung Soo HONG, Seoul (KR)

(73) Assignee: SAMSUNG ELECTRO-MECHANICS CO., LTD., Suwon-si (KR)

(21) Appl. No.: 13/407,992

(22) Filed: Feb. 29, 2012

(30) Foreign Application Priority Data
Mar. 4, 2011 (KR) 10-2011-0019611

(51) Int. Cl. H01F 27/28

(52) U.S. Cl. 336/170

(57) ABSTRACT

Provided is a choke coil including: a first primary winding portion formed by winding a primary coil by n turns; a second primary winding portion formed by winding the primary coil by N turns; a first secondary winding portion formed by winding a secondary coil by N turns; and a second secondary winding portion formed by winding the secondary coil by n turns, wherein the n and N satisfy the condition: n≦N.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2011-0019611, entitled filed Mar. 4, 2011, which is hereby incorporated by reference in its entirety into this application.

### BACKGROUND OF THE INVENTION

1. Field of the Invention

The present invention relates to a choke coil, and more particularly, to a choke coil capable of being used as a common mode filter of an EMI filter and so on.

2. Description of the Related Art

Recently, various problems due to electromagnetic noise have occurred according to the trend of miniaturization, slimming, and high processing speed of products in the market of flat panel displays (FPDs) such as liquid crystal displays (LCDs), plasma display panels (PDPs), and organic light emitting diodes (OLEDs).

Especially, in a flat panel display device, since large electromagnetic noise is caused by a power converter, an image board, semiconductor devices and so on, various EMI filters are used to suppress electromagnetic noise.

Electromagnetic noise of electronic devices can be largely classified into two types: conducted emission and radiated emission, and each of them can be classified into differential mode noise and common mode noise again. At this time, an EMI filter mainly uses a normal mode choke and an X-capacitor for reduction of differential mode noise and a common mode choke and a Y-capacitor for reduction of common mode noise.

Meanwhile, a choke coil used for an EMI filter can reduce common mode noise by a magnetizing inductance (Lm) characteristic and differential mode noise by a leakage inductance (Lk) characteristic.

However, since a conventional UU type choke coil has a relatively high leakage inductance characteristic compared to a magnetizing inductance characteristic, a leakage inductance value secured in an optimum condition for reduction of common mode noise is sufficient, but a leakage inductance characteristic is excessive. Therefore, there was a limit to slimming of the choke coil due to noise caused by a collision between magnetic flux and devices around the choke coil or a back cover and so on.

Further, since a conventional general toroidal type choke coil has a relatively low leakage inductance characteristic compared to a magnetizing inductance characteristic, a leakage inductance value in an optimum condition for reduction of common mode noise is insufficient to reduce differential mode noise. Due to this, there was a problem that a separate means was required for additional reduction of differential mode noise.

Meanwhile, in case of a flat panel display device, it is required to implement a low height of a common mode choke coil according to the trend of slimming of exterior design. A conventional general choke coil has a structure in which both a primary coil and a secondary coil are wound around a toroidal type core. In this toroidal type choke coil, since it was difficult to implement automation of winding so that winding operation should be performed manually, there were problems of low manufacturing efficiency and relatively high product cost.

### SUMMARY OF THE INVENTION

The present invention has been invented in order to overcome the above-described problems and it is, therefore, an object of the present invention to provide a choke coil capable of reducing the amount of magnetic flux leaking outside.

Further, it is another object of the present invention to provide a choke coil capable of independently adjusting leakage inductance.

Furthermore, it is still another object of the present invention to provide a choke coil capable of securing competitiveness through reduction of manufacturing costs by providing a choke coil which can be manufactured by an automatic winding method.

In accordance with one aspect of the present invention to achieve the object, there is provided a choke coil including: a first primary winding portion formed by winding a primary coil by n turns; a second primary winding portion formed by winding the primary coil by N turns; a first secondary winding portion formed by winding a secondary coil by N turns; and a second secondary winding portion formed by winding the secondary coil by n turns, wherein n and N satisfy the condition: n≦N.

In accordance with another aspect of the present invention to achieve the object, there is provided a choke coil including: a first primary winding portion formed by winding a primary coil by n turns; a second primary winding portion formed by winding the primary coil by N turns; a first secondary winding portion formed by winding a secondary coil by M turns; and a second secondary winding portion formed by winding the secondary coil by m turns, wherein n and N satisfy the condition: n≦N, and m and M satisfy the condition: m≦M.

At this time, the choke coil may further include cores disposed inside the first primary winding portion, the second primary winding portion, the first secondary winding portion, and the second secondary winding portion to be separated from each winding portion.

At this time, the cores may be integrally connected.

Further, the primary coils, which form the first primary winding portion and the second primary winding portion, may be connected in series, and the secondary coils, which form the first secondary winding portion and the second secondary winding portion, may be connected in series.

Further, the core may include two legs, wherein the first primary winding portion and the first secondary winding portion may be positioned in the same leg, and the second primary winding portion and the second secondary winding portion may be positioned in the same leg.

Meanwhile, in accordance with still another aspect of the present invention to achieve the object, there is provided a choke coil including a primary coil, a secondary coil, and a core including: a first bobbin including a first primary winding region around which the primary coil is wound, a first secondary winding region around which the secondary coil is wound, and a core insertion portion formed on inner surfaces of the first primary winding region and the first secondary winding region; and a second bobbin including a second primary winding region around which the primary coil is wound, a second secondary winding region around which the secondary coil is wound, and a core insertion portion formed on inner surfaces of the second primary winding region and the second secondary winding region.

At this time, the choke coil may include a first primary winding portion formed by winding the primary coil around the first primary winding region by n turns; a second primary winding portion formed by winding the primary coil around the second primary winding region by N turns; a first secondary winding portion formed by winding the secondary coil around the first secondary winding region by N turns; and a second secondary winding portion formed by winding the secondary coil around the second secondary winding region by n turns, wherein n and N may satisfy the condition: n≦N.

Further, the choke coil may include a first primary winding portion formed by winding the primary coil around the first primary winding region by n turns; a second primary winding portion formed by winding the primary coil around the second primary winding region by N turns; a first secondary winding portion formed by winding the secondary coil around the first secondary winding region by M turns; and a second secondary winding portion formed by winding the secondary coil around the second secondary winding region by m turns, wherein n and N may satisfy the condition: n≦N, and m and M may satisfy the condition: m≦M.

Further, the first bobbin and the second bobbin may further include partitions protruded from boundary points between the primary winding regions and the secondary winding regions.

Further, the first bobbin and the second bobbin may further include a plurality of terminals electrically connected to ends of the primary coil and the secondary coil, respectively.

Further, the first bobbin and the second bobbin may further include a plurality of coil drawing grooves through which the primary coil and secondary coil are drawn outside from the winding regions.

Further, the first bobbin and the second bobbin include projecting portions and groove portions formed on side surfaces opposite to each other, respectively, wherein the projecting portion of the first bobbin may be inserted in the groove portion of the second bobbin, and the projecting portion of the second bobbin may be inserted in the groove portion of the first bobbin.

Further, the at least one coil drawing groove may start from the outside of an outer peripheral surface of the winding region in a direction going away from the winding region.

Further, the at least one coil drawing groove may include an inclined portion which starts from the winding region to be inclined toward the outside of an outer peripheral surface of the winding region in a direction going away from the winding region.

At this time, a portion between the inclined portion and an outer surface of the first bobbin or the second bobbin may be opened.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an electrical connection diagram of a choke coil structure in accordance with the present invention;

FIG. 2 is a view showing a configuration of a choke coil in accordance with the present invention;

FIG. 3 is a perspective view showing a configuration in accordance with an embodiment of the present invention;

FIG. 4 is a disassembled perspective view of FIG. 3;

FIG. 5(a) is a plan view of FIG. 3;

FIG. 5(b) is a bottom view of FIG. 3;

FIG. 5(c) is a side view showing a side configuration of a portion of FIG. 3;

FIG. 6 is a bottom view showing a bottom configuration in accordance with another embodiment of the present invention;

FIG. 7 is a bottom view showing a bottom configuration in accordance with still another embodiment of the present invention;

FIG. 8 is a perspective view showing a configuration and an application example in accordance with a third embodiment of the present invention;

FIG. 9 is a bottom view showing the configuration in accordance with the third embodiment of the present invention;

FIG. 10 is a view showing an application example of the present invention;

FIG. 11(a) is a graph showing EMI measurement results of an EMI filter to which the present invention is applied; and

FIG. 11(b) is a graph showing EMI measurement results of an EMI filter to which a choke coil of the prior art is applied.

### DETAILED DESCRIPTION OF THE PREFERABLE EMBODIMENTS

Advantages and features of the present invention and methods of accomplishing the same will become apparent with reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Hereinafter, a configuration and an operation of the present invention will be described in detail with reference to the accompanying drawings.

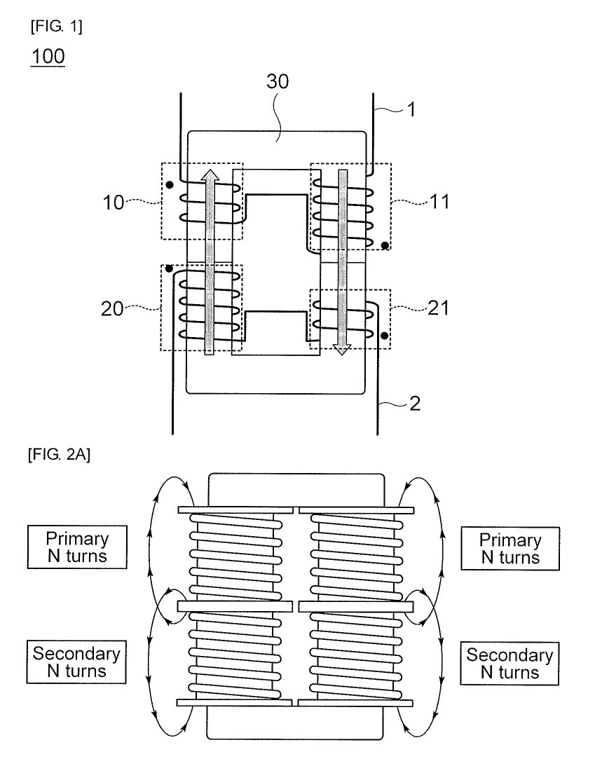

FIG. 1 is an electrical connection diagram of a choke coil structure in accordance with the present invention, and FIG. 2 is a view showing a configuration of a choke coil in accordance with the present invention. Referring to FIGS. 1 and 2, a choke coil 100 in accordance with the present invention includes a first primary winding portion 10 formed by winding a primary coil 1 by n turns; a second primary winding portion 11 formed by winding the primary coil 1 by N turns; a second primary winding portion 20 formed by winding a secondary coil 2 by N turns; and a second secondary winding portion 21 formed by winding the secondary coil 2 by n turns, and n and N may satisfy the condition: n≦N.

For example, n and N may satisfy the condition: n=N=5 (Refer to FIG. 2(a)) or the condition: n=3, N=5 (Refer to FIG. 1).

At this time, the first primary winding portion 10 and the second primary winding portion 11 may be the same as those described above, the first secondary winding portion 20 may be formed by winding the secondary coil 2 by M turns, and the second secondary winding portion 21 may be formed by winding the secondary coil 2 by m turns.

For example, n, N, M and m may satisfy the condition: n=3, N=5, M=4.5 and m=2.5.

Meanwhile, the choke coil 100 may further include cores 30 disposed inside the first primary winding portion 10, the second primary winding portion 11, the first secondary winding portion 20, and the second secondary winding portion 20 to be separated from each winding portion.

At this time, the cores 30 may be integrally connected.

That is, after forming the winding portions, the two U type cores 30 may be inserted in the winding portions to be integrally connected to each other.

Further, when considering manual winding, the winding portions may be formed by winding the primary coil 1 and the secondary coil 2 around ▭-shaped integrated core, respectively.

Further, the primary coils 1, which form the first primary winding portion 10 and the second primary winding portion 11, may be connected in series, and the secondary coils 2, which form the first secondary winding portion 20 and the second secondary winding portion 21, may be connected in series.

At this time, when the choke coil 100 is applied to an EMI filter, the primary coil 1 and the secondary coil 2 may be connected to a live side or a neutral side of the EMI filter.

Further, the core 30 includes two legs. The first primary winding portion 10 and the first secondary winding portion 20 may be positioned in the same leg, and the second primary winding portion 11 and the second secondary winding portion 21 may be positioned in the same leg.

FIG. 2 is a view showing a configuration of the choke coil 100 in accordance with the present invention. Referring to FIG. 2, FIG. 2(a) shows a case in which all the winding portions have the same number of turns, and FIG. 2(b) shows a case in which all the winding portions have the different number of turns.

In a structure shown in FIG. 2(a), since the primary and secondary winding portions of each leg have regions in which magnetic fluxes are generated in a direction of canceling each other, external magnetic flux leakage is reduced than a conventional general UU type choke coil, thereby improving problems such as noise and malfunction compared to the conventional choke coil.

In a structure shown in FIG. 2(b), a principle that external magnetic flux leakage due to coupling is increased by asymmetrically winding a primary side and a secondary side is shown.

Further, in the structure shown in FIG. 2(b), it is possible to control external magnetic flux leakage due to coupling by varying a turns ratio of n:N of the primary side and the secondary side. At this time, it is possible to implement the control of external magnetic flux leakage while minimizing a change in magnetizing inductance characteristic of the choke coil.

Therefore, when the choke coil 100 in accordance with the present invention is applied to various products to implement an EMI filter, after basic properties are determined according to a magnetizing inductance characteristic, since it is possible to adjust leakage flux in consideration of characteristics of differential mode noise that is required to be reduced, it is possible to configure the choke coil 100 optimized for removal of common mode noise and differential mode noise.

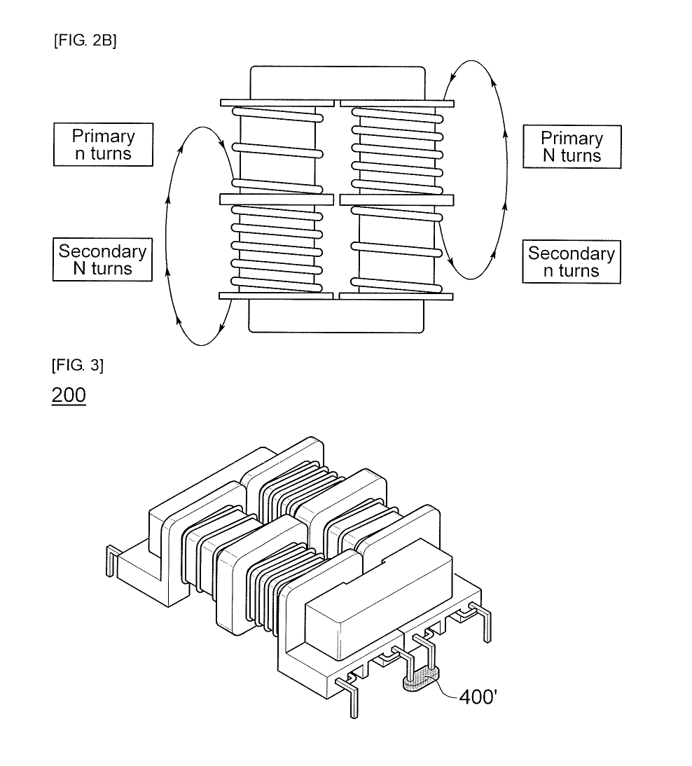

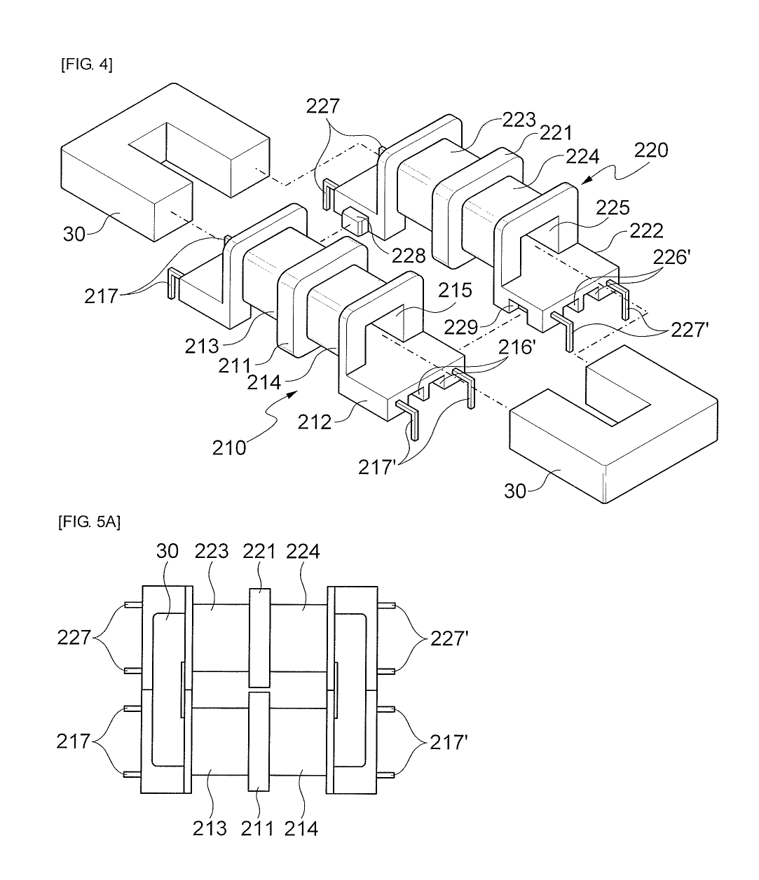

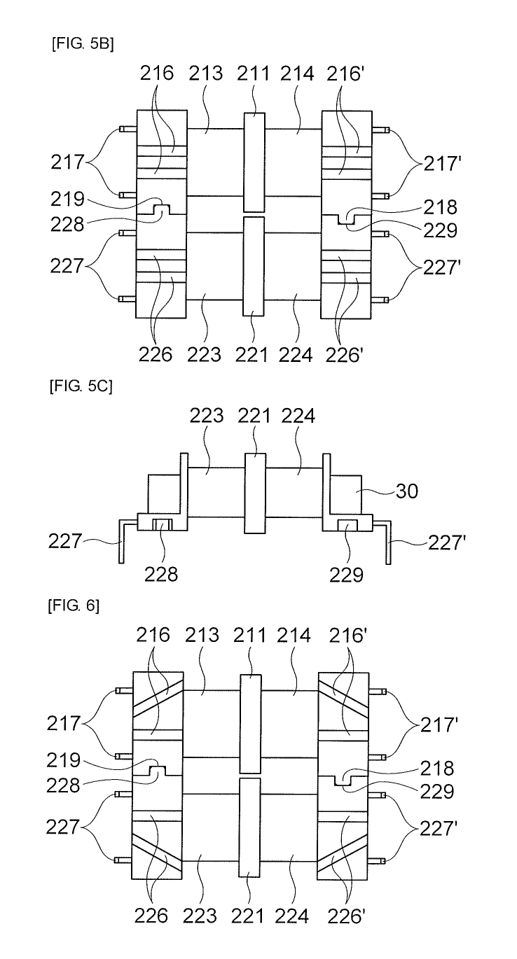

FIG. 3 is a perspective view showing a configuration in accordance with an embodiment of the present invention, FIG. 4 is a disassembled perspective view of FIG. 3, FIG. 5(a) is a plan view of FIG. 3, FIG. 5(b) is a bottom view of FIG. 3, and FIG. 5(c) is a side view showing a side configuration of a portion of FIG. 3. Hereinafter, a configuration of a choke coil 200 in accordance with an embodiment of the present invention will be described in detail with reference to the above drawings.

A choke coil 200 including a primary coil 1, a secondary coil 2, and a core 30 in accordance with the present invention may include a first bobbin 210 including a first primary winding region 213 around which the primary coil 1 is wound, a first secondary winding region 214 around which the secondary coil 2 is wound, and a core insertion portion 215 formed on inner surfaces of the first primary winding region 213 and the first secondary winding region 214; and a second bobbin 220 including a second primary winding region 223 around which the primary coil 1 is wound, a second secondary winding region 224 around which the secondary coil 2 is wound, and a core insertion portion 225 formed on inner surfaces of the second primary winding region 223 and the second secondary winding region 224.

At this time, the choke coil 200 in accordance with the present invention may include a first primary winding portion 10 formed by winding the primary coil 1 around the first primary winding region 213 by n turns; a second primary winding portion 11 formed by winding the primary coil 1 around the second primary winding region 223 by N turns; a first secondary winding portion 20 formed by winding the secondary coil 2 around the first secondary winding region 214 by N turns; and a second secondary winding portion 21 formed by winding the secondary coil 2 around the second secondary winding region 224 by n turns, and n and N may satisfy the condition: n≦N.

For example, n and N may satisfy the condition: n=N=5 (Refer to FIG. 2(a)) or the condition: n=3, N=5 (Refer to FIG. 2(b)).

At this time, the first primary winding portion 10 and the second primary winding portion 11 may be the same as those described above, the first secondary winding portion 20 may be formed by winding the secondary coil 2 by M turns, the second secondary winding portion 21 may be formed by winding the secondary coil 2 by m turns, and m and M may satisfy the condition: m≦M.

For example, n, N, M and M may satisfy the condition: n=3, N=5, M=4.5 and m=2.5.

At this time, the first bobbin 210 and the second bobbin 220 may be made of an insulating material.

Referring to FIG. 4, the first primary winding portion 10 may be formed by winding the primary coil 1 around the first primary winding region 213 of the first bobbin 210, the first secondary winding portion 20 may be formed by winding the secondary coil 2 around the first secondary winding region 214 of the first bobbin 210, the second primary winding portion 11 may be formed by winding the primary coil 1 around the second primary winding region 223 of the second bobbin 220, and the second secondary winding portion 21 may be formed by winding the secondary coil 2 around the second secondary winding region 224 of the second bobbin 220.

Further, the first bobbin 210 and the second bobbin 220 may be disposed in parallel to be coupled to each other. The core 30 may be inserted in the core insertion portions 215 and 225 formed on inner surfaces of the first bobbin 210 and the second bobbin 220.

Meanwhile, partitions 211 and 221 may be formed on outer peripheral surfaces of the first bobbin 210 and the second bobbin 220. The partitions 211 and 221 may be protruded from boundary points between the primary winding regions 213 and 223 and the secondary winding regions 214 and 224 and perform a function of preventing electrical connection between the primary coil 1 and the secondary coil 2.

Further, when the first bobbin 210 and the second bobbin 220 are adjacent to each other, the partitions 211 and 221 may perform a function of preventing contact between the first primary winding portion 10 and the second primary winding portion 11 and between the first secondary winding portion 20 and the second secondary winding portion 21.

Further, the first bobbin 210 and the second bobbin 220 may further include a plurality of terminals 217 and 227 which are electrically connected to ends of the primary coil 1 and the secondary coil 2, respectively. Although the choke coil 200 in accordance with an embodiment of the present invention may be connected to a substrate and so on without the plurality of terminals 217 and 227, it is possible to improve efficiency of a process of coupling the choke coil 200 to the substrate by connecting the terminals 217 and 227, which are firmly coupled to the first bobbin 210 and the second bobbin 220, to the ends of the coils.

Meanwhile, in FIG. 3, the reference numeral 400′ indicates terminal connection means 400 and 400′ which electrically connect the terminals.

In the choke coil 200 in accordance with the present invention, the primary coils 1, which form the first primary winding portion 10 and the second primary winding portion 11, may be connected in series, and the secondary coils 2, which form the first secondary winding portion 20 and the second secondary winding portion 21, may be connected in series. At this time, the primary coil 1 and the secondary coil 2 may be connected to the terminals. The terminals 217 and 227 may be electrically connected by the terminal connection means 400 and 400′. At this time, the terminal connection means may be implemented as the well-known soldering and so on.

Further, projecting portions 218 and 228 and groove portions 219 and 229 may be formed on side surfaces of the first bobbin 210 and the second bobbin 220 to face each other. The projecting portion 218 of the first bobbin 210 may be inserted in the groove portion 229 of the second bobbin 220, and the projecting portion 228 of the second bobbin 220 may be inserted in the groove portion 219 of the first bobbin 210.

Further, the first bobbin 210 and the second bobbin 220 may further include a plurality of coil drawing grooves 216 through which the primary coil 1 and the secondary coil 2 are drawn outside from the winding regions. When not including the coil drawing grooves 216, the first bobbin 210 and the second bobbin 220 separately require a thickness corresponding to a diameter of the coil when the coil wound around the winding region is drawn from the winding portion to be connected to the outside or the above-described plurality of terminals.

Further, if there is no coil drawing groove 216, there may be a concern about contact between the coil and other wirings of the substrate when the coil is drawn from a lower surface of the choke coil 200, that is, a surface in contact with the substrate.

Therefore, it is possible to slim the choke coil 200 and overcome connection with the wirings of the substrate by including the coil drawing grooves 216 shown in an embodiment of the present invention.

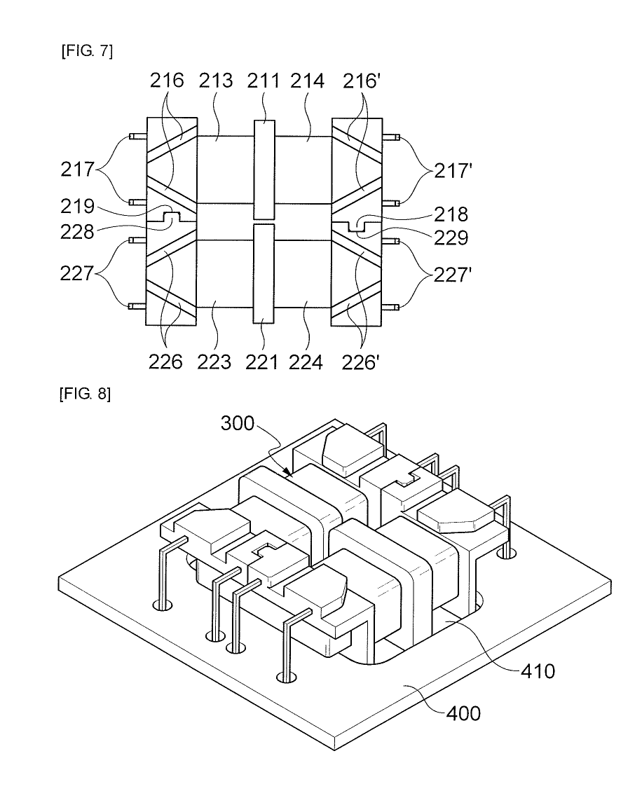

FIGS. 6 and 7 are bottom views showing a bottom configuration in accordance with another embodiment of the present invention. Through the following description referring to FIGS. 6 and 7, it will be possible to understand a principle that the choke coil 100 can be slimmed and miniaturized by optimizing a position and a direction of the coil drawing groove 216.

As shown in the drawings, lead frames 212 may be formed in the first bobbin 210 and the second bobbin 220 in a direction from the winding regions 213, 214, 223, and 224 to the outside. The terminals 217 and 227 may be fixed to the lead frames 212, and the coil drawing grooves 216 may be formed in the lead frames 212.

The coil drawing grooves 216 may be freely formed on the lead frame 212 but it is preferred that the coil drawing groove 216 are separated from the portions to which the terminals are fixed by a predetermined distance to minimize a thickness of the lead frame 212 and thus to reduce raw material costs.

Meanwhile, since the coil itself has a predetermined diameter, when including the coil drawing grooves 216 as shown in FIG. 5(b), a thickness greater than a thickness of a strand of coil is required.

For example, when the number of turns of the coil wound around the winding regions 213, 223, 214, and 224 is large and the winding regions 213, 223, 214, and 224 are narrow, the coil should be wound two or three fold, a winding starting from one end of the coil is in contact with the winding regions 213, 223, 214, and 224, the other end of the coil, an end point of the winding, is positioned in the winding regions 213, 223, 214, and 224 around which the coil is wound two or three fold. Therefore, vertical heights of one end and the other end of the coil are different from each other by a distance of greater than one time of the diameter of the coil. Therefore, when including the coil drawing grooves 216 as shown in FIG. 5(b), a thickness greater than a thickness of a strand of coil is additionally required.

However, as shown in FIG. 6, when the coil drawing grooves 216 start from the outside of outer peripheral surfaces of the winding regions 213, 223, 214, and 224 on the lead frames 212, the other end of the coil, that is, the end point of the winding can be directly drawn to the outside through the coil drawing groove 216 without going to a bottom portion of the choke coil 200. Therefore, it is possible to reduce the thickness of the entire choke coil 200 as large as a thickness of a strand of coil.

Meanwhile, when the coil drawing grooves 216 are formed adjacent to portions in which the terminals 217, 227, 217′, and 227′ are coupled to the lead frames 212, since there is a problem that it is not possible to firmly fix the terminals 217, 227, 217′, and 227′ and the lead frames 212, it is preferred that the coil drawing grooves 216 are separated from the portions in which the terminals 217, 227, 217′, and 227′ are coupled to the lead frames 212 by a predetermined distance.

At this time, when the terminals 217, 227, 217′, and 227′ are coupled to the lead frames 212 without being sufficiently separated from outer surfaces of the bobbins 210 and 220, the coil drawing grooves 216 may be formed between the terminals 217, 227, 217′, and 227′ and center axes of the bobbins 210 and 220.

Further, when the terminals 217, 227, 217′, and 227′ are coupled to the lead frames 212 while being sufficiently separated from the outer surfaces of the bobbins 210 and 220, the coil drawing grooves 216 may be formed between the terminals 217, 227, 217′, and 227′ and the outer surfaces of the bobbins 210 and 220.

Further, as shown in FIG. 7, all of the coil drawing grooves 216 may start from the outside of the outer peripheral surfaces of the winding regions 213, 223, 214, and 224 on the lead frames 212.

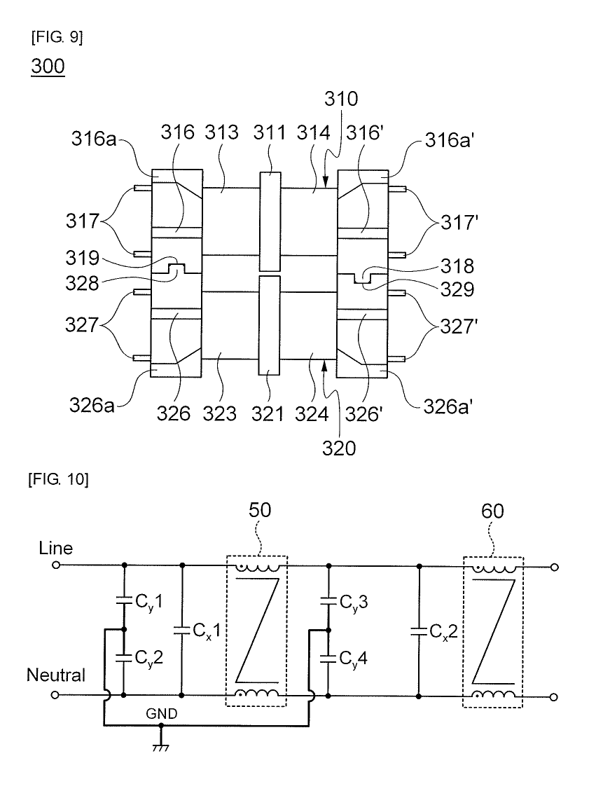

FIG. 8 is a perspective view showing a configuration and an application example in accordance with a third embodiment of the present invention, and FIG. 9 is a bottom view showing the configuration in accordance with the third embodiment of the present invention.

Referring to FIGS. 8 and 9, a choke coil 300 in accordance with a third embodiment of the present invention may include at least one or more coil drawing grooves 316a and 326a which have inclined portions starting from winding regions 313, 323, 314, and 324 to be inclined toward the outside of outer peripheral surfaces of the winding regions 313, 323, 314, and 324 in a direction going away from the winding regions 313, 323, 314, and 324.

At this time, a portion between the inclined portion and an outer surface of a first bobbin 310 or a second bobbin 320 may be opened.

When including the coil drawing grooves 316a and 326a shown in FIGS. 8 and 9, it is possible to improve work efficiency in a process of connecting a coil to a terminal after winding of the coil.

Meanwhile, although FIG. 8 shows an example that the choke coil 300 in accordance with the third embodiment of the present invention is mounted on a substrate 400, referring to FIG. 8, it is possible to reduce thickness increase due to a choke coil in various devices to which the choke coil is applied by forming a concave groove 410 in the substrate 400 and inserting all or a portion of the choke coil in the concave groove 410 to be connected to the terminal. Therefore, when applying the choke coil in accordance with the present invention, it is possible to contribute to slimming of various electronic devices. Meanwhile, as shown in FIG. 8, the choke coil may be mounted on the substrate 400 while being turned over.

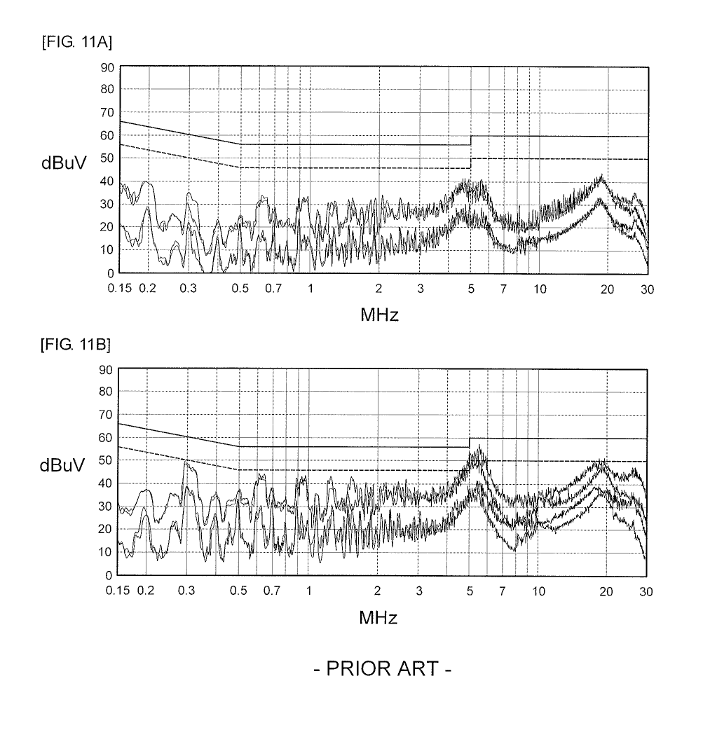

FIG. 10 is a view showing an application example of the present invention and shows an EMI filter structure including two choke coils 100, 200, and 300. FIG. 11(a) is a graph showing EMI measurement results of an EMI filter to which the present invention is applied, and FIG. 11(b) is a graph showing EMI measurement results of an EMI filter to which a choke coil of the prior art is applied.

When comparing EMI noise levels of FIG. 11(a) and FIG. 11(b), it is possible to check that EMI noise in the entire frequency band is sufficiently reduced in the EMI filter to which the choke coil 100 in accordance with the present invention is applied.

Since the present invention configured as above can reduce the amount of magnetic flux leaking outside even in a UU type choke coil, it can provide a useful effect that it is possible to overcome circuit malfunction and noise problems due to magnetic flux leaking outside a choke coil.

Further, since the present invention provides a choke coil capable of independently adjusting leakage inductance, it can overcome circuit malfunction and noise problems as well as being optimized for suppression of noise according to circumstances.

Further, since the present invention provides a choke coil which can be manufactured by an automatic winding method, it can provide a choke coil capable of securing competitiveness through reduction of manufacturing costs.

Further, since the present invention can manufacture a choke coil by using only minimum raw materials, it can provide a choke coil more advantageous for reduction of manufacturing costs and slimming.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A choke coil comprising:
a first primary winding portion formed by winding a primary coil by n turns;
a second primary winding portion formed by winding the primary coil by N turns;
a first secondary winding portion formed by winding a secondary coil by N turns; and
a second secondary winding portion formed by winding the secondary coil by n turns, wherein n and N satisfy the condition: n≦N.

2. A choke coil comprising:
a first primary winding portion formed by winding a primary coil by n turns;
a second primary winding portion formed by winding the primary coil by N turns;
a first secondary winding portion formed by winding a secondary coil by M turns; and
a second secondary winding portion formed by winding the secondary coil by m turns, wherein n and N satisfy the condition: n≦N, and m and M satisfy the condition: m≦M.

3. The choke coil according to claim 1, further comprising cores disposed inside the first primary winding portion, the second primary winding portion, the first secondary winding portion, and the second secondary winding portion to be separated from each winding portion.

4. The choke coil according to claim 3, wherein the cores are connected each other.

5. The choke coil according to claim 1, wherein the primary coils, which form the first primary winding portion and the second primary winding portion, are connected in series, and the secondary coils, which form the first secondary winding portion and the second secondary winding portion, are connected in series.

6. The choke coil according to claim 3, wherein the core comprises two legs, wherein the first primary winding portion and the first secondary winding portion are positioned in the same leg, and the second primary winding portion and the second secondary winding portion are positioned in the same leg.

7. A choke coil comprising a primary coil, a secondary coil, and a core, comprising:
a first bobbin comprising a first primary winding region around which the primary coil is wound, a first secondary winding region around which the secondary coil is wound, and a core insertion portion formed on inner surfaces of the first primary winding region and the first secondary winding region; and
a second bobbin comprising a second primary winding region around which the primary coil is wound, a second secondary winding region around which the secondary coil is wound, and a core insertion portion formed on inner surfaces of the second primary winding region and the second secondary winding region.

8. The choke coil according to claim 7, comprising:
a first primary winding portion formed by winding the primary coil around the first primary winding region by n turns;
a second primary winding portion formed by winding the primary coil around the second primary winding region by N turns;
a first secondary winding portion formed by winding the secondary coil around the first secondary winding region by N turns; and
a second secondary winding portion formed by winding the secondary coil around the second secondary winding region by n turns, wherein n and N satisfy the condition: n≦N.

9. The choke coil according to claim 7, comprising:
a first primary winding portion formed by winding the primary coil around the first primary winding region by n turns;
a second primary winding portion formed by winding the primary coil around the second primary winding region by N turns;
a first secondary winding portion formed by winding the secondary coil around the first secondary winding region by M turns; and
a second secondary winding portion formed by winding the secondary coil around the second secondary winding region by m turns, wherein n and M satisfy the condition: n≦N, and m and M satisfy the condition: m≦M.

10. The choke coil according to claim 7, wherein the first bobbin and the second bobbin further comprise partitions protruded from boundary points between the primary winding regions and the secondary winding regions.

11. The choke coil according to claim 7, wherein the first bobbin and the second bobbin further comprise a plurality of terminals electrically connected to ends of the primary coil and the secondary coil, respectively.

12. The choke coil according to claim 7, wherein the first bobbin and the second bobbin further comprise a plurality of coil drawing grooves through which the primary coil and the secondary coil are drawn outside from the winding regions.

13. The choke coil according to claim 7, wherein the first bobbin and the second bobbin comprise projecting portions and groove portions formed on side surfaces opposite to each other, respectively, wherein the projecting portion of the first bobbin is inserted in the groove portion of the second bobbin, and the projecting portion of the second bobbin is inserted in the groove portion of the first bobbin.

14. The choke coil according to claim 12, wherein the at least one coil drawing groove starts from the outside of an outer peripheral surface of the winding region in a direction going away from the winding region.

15. The choke coil according to claim 12, wherein the at least one coil drawing groove comprises an inclined portion which starts from the winding region to be inclined toward the outside of an outer peripheral surface of the winding region in a direction going away from the winding region.

16. The choke coil according to claim 15, wherein a portion between the inclined portion and an outer surface of the first bobbin or the second bobbin is opened.
